(19) United States
(12) Patent Application Publication
(10) Pub. No.: US 2009/0059782 A1
(43) Pub. Date: Mar. 5, 2009

(54) Method and apparatus for extending the transmission capability of twisted pair communication systems

(75) Inventor: Gary Dean Cole, Corona, CA (US)

Correspondence Address: THE HECKER LAW GROUP, 1925 CENTURY PARK EAST, SUITE 2300, LOS ANGELES, CA, 90067, US

(73) Assignee: RGB Systems, Inc.

(21) Appl. No.: 11/897,518

(22) Filed: Aug. 29, 2007

(51) Int. Cl. H04J 11/00; H04L 27/36

(52) U.S. Cl. 370/206; 375/298; 375/345

(57) ABSTRACT

A closed loop feedback system is employed in a receiver to automatically compensate the communication signal from twisted pair cables for AC and DC losses. This is accomplished through the use of a reference pulse signal which is sent along with other digital information. At the receiver, the reference pulse signal is restored to its proper level through a Pulse Width Modulation (PWM)-controlled variable compensation amplifier circuit. The received reference signal is compared to a known reference value and the duty cycle of the PWM circuit is adjusted until the proper level reference signal is achieved. Thereafter, the digital signal is extracted. OFDM (Orthogonal Frequency Division Multiplexing) with pilot tones are used to maximize payload while minimizing crosstalk effects. The pilot tones locate the OFDM symbols in time while supplying compensation information concerning the transmission medium.

### FIELD OF THE INVENTION

The present invention relates to communication systems. More specifically, the invention relates to a method and apparatus for extending the transmission capability of twisted pair communication systems.

### BACKGROUND

Transmission cables are used to convey electronic signals from a source device to a destination device, e.g., a display terminal. The cable may not accurately convey the signals because of losses which accumulate along the cable path. These losses are primarily due to the physical characteristics of the transmission cable and sometimes due to imperfections in the cable construction. The imperfections may not necessarily be due to manufacturing deficiencies, but may also be due to the fact that a cable is a physical device and most physical devices exhibit some losses when a signal is conveyed through them. Thus, longer length transmission cables tend to exhibit more loss (also known as “cable insertion” loss) than shorter length cables. A length limit exists for each transmission cable medium after which a video signal may no longer be discernable.

Video may be transmitted either in digital or analog format. For digital video transmission such as computer video, cable insertion loss is generally not an issue because the digital signal can be recovered so long as discernable digital pulses are detected by a receiver. A pulse-detection method and apparatus is described, for example, in commonly owned and concurrently filed U.S. utility patent application (Attorney Docket No. 74200.1007) entitled “Method and Apparatus for Improving the Quality of a Transmitted Video Signal,” the specification of which is incorporated herein in its entirety by reference. For analog signals such as NTSC (National Television Standards Committee) video signals, the signal comprises varying voltages with the voltages being affected by wire length, connectors, heat, cold, materials, manufacturing processes, and/or other conditions.

Cable insertion loss varies with the type of transmission medium. For instance, coaxial cables are known to exhibit less insertion loss than twisted pair cables, thus coaxial cables are the medium of choice for video transmission. Also, because of its superior performance over twisted pair cables, coaxial cables are typically used for transmission of high resolution (i.e., broadband) video signals. However, coaxial cables are more expensive and difficult to install when compared to twisted pair cables.

Historically, the significant differences between coaxial and twisted pair cables limited twisted pair cables to transmission of low-resolution video (i.e., less than 10 MHz) signals. However, twisted pair cables have a distinct advantage over coaxial cables, namely, the cost/performance ratio. Dollar-for-dollar, twisted pair cables are significantly cheaper to purchase and/or install than coaxial or fiber optic cable. A standard twisted pair cable contains four pairs of conductors in a single cable so that the actual cost per pair is one-quarter of the per-foot price.

Analog video specifications such as C-Video, S-Video, or YUV (or YIQ) may be available in various color models. A color model (also known as “color space”) defines colors in some standard, generally accepted way. For example, the RGB color model includes R for the red component; G for the green component; and B for the blue component.

Data-grade twisted pair cable comes in two types: unshielded twisted pairs commonly called UTP, and STP (shielded twisted pairs). By far, most of the domestic data installations tend to employ UTP cables.

In the mid 1980's, twisted pair technology began to emerge which could transmit 2 Mbps (Megabits per second), then 4 Mbps (the original IBM data rate), and then 10 Mbps. As data rates increased, it became apparent that some means of assessing twisted pair cable performance was needed. It was at that time that a system of “Levels” was proposed. The TIA (Telecommunications Industry Association)/EIA (Electronics Industries Alliance), two groups that set standards for the communications industry, adopted the proposal and separated the data rates and other parameters into “Categories”, such as Category (CAT) 3, 4, 5, and 6. Each higher numbered category has more stringent requirements with higher data rates and higher performance than the previous category.

The specifications for each category are given in TIA/EIA-568-B. TIA/EIA-568-B is a set of three telecommunications standards published by the TIA. The standards address commercial building cabling for telecommunication products and services. The three standards are formally titled ANSI/TIA/EIA-568-B.1-2001, -B.2-2001, and -B.3-2001. The TIA/EIA-568-B standards were first published in 2001 and supersede the TIA/EIA-568-A standards set, which is now obsolete. For example, the TIA/EIA-568-B.1-2001 defines the pin/pair assignments for eight-conductor 100-ohm balanced twisted pair cabling. These assignments are named T568A and T568B.

With regard to appearance, present-day twisted pair cables look identical to the plain old telephone service cable. The cables use the same color code and come in many of the same pair counts and use the same gauge conductors. However, the specifications they are made to, the materials used to make them, and the requirements to connect them, become more and more critical as data rates increase.

The 4th pair of the CAT 5, 6, or 7 wire bundle may be used to convey power and digital communications between a transmitter to a receiver, and digital communications from the receiver to the transmitter. The digital communications have identification bits, which identify the transmitting device. Many transmitters may transmit into the same communication link. Collision may be detected by CRC (Cyclic Redundancy Check) error checks.

High-resolution analog video such as RGB requires that each color component be transmitted separately to a destination device. For such transmission, a coaxial cable setup will require three separate coaxial cables to carry each color component and another cable to carry audio data. In contrast, a twisted pair setup only requires one twisted pair cable for all the video components, and a spare pair of conductors for audio and other communication needs. For instance, each of the three color components of the RGB format video may use one out of the four twisted pair conductors in the cable bundle, and the last (i.e. fourth) twisted pair may be used for power and/or digital communication needs. Thus, twisted pair bundles have a clear advantage over coaxial cables in terms of installation and costs.

Conventional video transmission systems over twisted pair cable have been known to be limited to about 300 feet distance because of the high rate of insertion loss in the transmission cable. Thus, to communicate video and audio over distances greater than 300 feet with current twisted pair technology would require possibly serially connecting multiple transmitter/receiver combinations to handle the required distance. Such setup would result in significant cost and waste. The cost of additional equipment may become prohibitive because each additional transmitter/receiver combination in the transmission path contributes to wasted energy with signal quality degrading as the signal is passed from one device to another.

Various methods for compensation of signal transmission errors have been used. Specifically, methods and apparatuses to compensate for phase, DC error, AC loss, and skew error are described, for example, in commonly owned U.S. patent application Ser. No. 11/309,120, filed Jun. 23, 2006, and entitled “Method and Apparatus for Automatic Compensation of Skew in Video Transmitted over Multiple Conductors,” U.S. patent application Ser. No. 11/309,123, filed Jun. 23, 2006, and entitled “Method and Apparatus for Automatic Reduction of Noise in Video Transmitted over Conductors,” U.S. patent application Ser. No. 11/309,558, filed Aug. 22, 2006, and entitled “Method and Apparatus for DC Restoration Using Feedback,” U.S. patent application Ser. No. 11/557,938, filed Nov. 7, 2006, and entitled “Method and Apparatus for Video Transmission over Long Distances Using Twisted Pair Cables,” and U.S. patent application Ser. No. 11/309,122, filed Jun. 23, 2006, and entitled “Method and Apparatus for Automatic Compensation of Video Signal Losses from Transmission over Conductors,” the specifications of which are incorporated herein in their entirety by reference.

Moreover, video systems are moving to higher and higher resolutions, which traditional twisted pair systems cannot handle. Thus, the need exists for transmission of high-resolution video and/or audio over distances longer than presently possible with known twisted pair communication systems.

### SUMMARY OF THE INVENTION

Some embodiments disclosed herein are generally directed to an apparatus for extending the transmission capability of twisted pair communication systems.

In one embodiment of the present invention, a transmitter and a receiver are coupled in tandem over a twisted pair cable for communication of video signals, e.g. composite video, S-Video, computer-video, and other high resolution video, over long distances.

In another embodiment of the present invention, a closed loop feedback system is employed in the receiver to automatically compensate the communication signal from the twisted pair cables for AC and DC losses. This is accomplished primarily through the use of a reference pulse signal which is sent along with other digital information. At the receiver, the reference pulse signal is restored to its proper level through a pulse width modulation (PWM) controlled variable compensation amplifier circuit. The received reference signal is compared to a known reference value and the duty cycle of the PWM circuit is adjusted until the proper level reference signal is achieved. Thereafter, the digital signal is extracted.

Signal adjustment is accomplished through the use of pilot tone(s) embedded with the digital signal. The receiver detects and recovers the pilot tone and compares the waveform to a known reference. DC and peaking (i.e. AC) compensation may be added to the incoming analog signal to restore the received pilot tone (pulse) to the reference tones. For example, in one or more embodiments, a 1 MHz pilot tone with a known amplitude is transmitted on one of the twisted pairs of a twisted pair bundle that is not used for transmission of the video signal (e.g. the pair referred to as pins 3 and 6 of FIG. 2). The measured amplitude of that signal at the receiver is used to adjust the DC gain so that the received measured level is the same as the transmitted level. Another pilot tone at 7 MHz is also transmitted on the same pair. The difference in amplitude between the 1 MHz signal and the 7 MHz signal indicates the amount of compensation (“peaking”) required to restore the video signal.

A servo apparatus may be used to compare the two gains (for the 1 MHz and 7 MHz signals) and automatically adjust the peaking until the two levels are equal. The amount of gain required is used to indicate the effective distance the signal has traveled. This signal is used to automatically set the gain required for the other three (video) channels.

The compensated signal may be digitized and decoded. For instance, one embodiment of the present invention uses QAM (Quadrature Amplitude Modulation) and OFDM (Orthogonal Frequency Division Multiplexing) to encode the digital data. In the receiver, the digital data is processed through a Fast Fourier Transform (FFT) and a QAM demodulator to recover the digital data.

In accordance with one aspect of the present invention, an apparatus for extending the transmission capability of twisted pair communication systems comprises a transmitter utilizing orthogonal frequency division multiplexing (OFDM) to package digital data for transmission. The packaged digital data includes at least one embedded pilot tone for data loss compensation. The transmitter is configured to generate analog differential output from the packaged digital data.

The apparatus also includes a receiver which is operatively coupled to the transmitter over at least one twisted pair cable. The receiver is configured to recover the embedded pilot tone from the analog differential output of the transmitter. The receiver utilizes a closed loop feedback system and the recovered pilot tone to apply corresponding signal compensation to the analog differential output. The receiver is further configured to extract the transmitted digital data from the compensated signal.

In accordance with another aspect of the present invention, the apparatus comprises a transmitter configured to generate a plurality of analog signals, and a receiver operatively coupled to the transmitter over at least one twisted pair cable. The receiver applies compensation to the analog signals, whereby at least one of the analog signals is encoded with pilot tone and digital information. The compensation is generated by way of a variable compensation circuit which includes an active filter network with control signal based on the pilot tone. The receiver is remotely disposed from the transmitter and includes a digital data extraction circuit for recovering the digital information from the compensated analog signals.

In accordance with yet another aspect of the present invention, a method for extending the transmission capability of twisted pair communication systems comprises the steps of receiving an analog signal over at least one twisted pair cable, wherein the analog signal includes at least one pilot tone embedded with other digital information; applying compensation to the analog signal to generate a compensated analog signal, wherein the compensation includes frequency dependent gain and phase adjustments to the analog signal based on deviation of the pilot tone from a reference tone; and extracting the other digital information from the compensated analog signal.

In accordance with a further aspect of the present invention, the method comprises the steps of:

providing a transmitter which utilizes orthogonal frequency division multiplexing (OFDM) to package digital data for transmission;

embedding at least one embedded pilot tone for data loss compensation in the packaged digital data;

generating analog differential output from the packaged digital data;

operatively coupling a receiver to the transmitter over at least one twisted pair cable;

configuring the receiver to recover the embedded pilot tone from the analog differential output;

utilizing a closed loop feedback system and the recovered pilot tone in the receiver to apply corresponding signal compensation to the analog differential output; and

extracting the transmitted digital data from the compensated signal.

These and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a block diagram of a system configured for audio/video communication over long distances using twisted pair cable in accordance with an embodiment of the present invention;

FIG. 2 is a schematic illustration of allocation of the conductors of a twisted pair cable for various video formats in accordance with an embodiment of the present invention;

FIG. 3 is a schematic illustration of allocation of the conductors of a twisted pair cable for various video formats in accordance with another embodiment of the present invention;

FIG. 4 is a block diagram of an exemplary configuration of a transmitter in accordance with an embodiment of the present invention;

FIG. 5 is a block diagram of an exemplary configuration of a receiver in accordance with an embodiment of the present invention;

FIG. 6 schematically illustrates a differential gain and peaking network circuit in accordance with an embodiment of the present invention;

FIG. 7 schematically illustrates an AC and DC compensator circuit in accordance with an embodiment of the present invention;

FIG. 8 is a schematic illustration of a circuit configured for extraction of digital data in accordance with an embodiment of the present invention;

FIG. 9 is a frequency response plot of an exemplary 200 feet of CAT 5 cable;

FIG. 10 is an exemplary state diagram of a state machine which controls the FFT initiated by a symbol detect pulse in accordance with an embodiment the present invention; and

FIG. 11 is a schematic illustration of an exemplary symbol detection embodiment in accordance with the present invention.

### DETAILED DESCRIPTION OF THE INVENTION

The detailed description set forth below in connection with the appended drawings is intended as a description of illustrated exemplary embodiments and is not intended to represent the only forms in which these embodiments may be constructed and/or utilized. The description sets forth the functions and sequence of steps for constructing and operating the present invention in connection with the illustrated embodiments. However, it is to be understood that the same or equivalent functions and/or sequences may be accomplished by different embodiments that are also intended to be encompassed within the spirit and scope of the present invention.

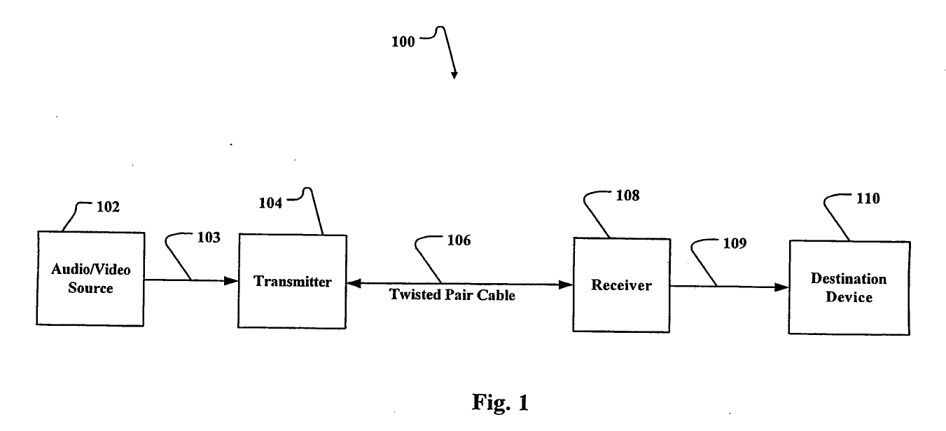

Some embodiments of the present invention will be described in detail with reference to a method and apparatus for extending the transmission capability of twisted pair communication systems, as generally depicted in reference to FIGS. 1-10. Additional embodiments, features and/or advantages of the invention will become apparent from the ensuing description or may be learned by practicing the invention. In the attached figures, the various drawings are not to scale with like numerals referring to like features throughout both the drawings and the description.

FIG. 1 is a block diagram of a system configured for audio/video communication over long distances using twisted pair cable in accordance with an embodiment of the present invention. Audio/video communication over “long” distances is generally defined herein for the purpose of describing the general principles of the present invention as transmission of audio and/or video signals over longer distances than presently possible with known systems.

Audio/video communication system 100 includes a transmitter 104 which is operatively coupled between an audio/video source 102 and a receiver 108. Transmitter 104 is configured to accept and process most audio and video formats originating from audio/video source 102 over transmission cable bundle 103. Transmitter 104 communicates with receiver 108 via a twisted pair cable 106.

Transmitter 104 receives video and audio signals from audio/video source 102, processes the same and differentially transmits output signals over twisted pair cable 106. Each of transmitter 104 and receiver 108 may include circuits for bi-directional digital communication. Bi-directional communication may be necessary to request a resend of data when the transmitted data is corrupted.

Transmission cable bundle 103 may include any combination of conductors suitable for coupling video and/or audio signals from source 102. The video conductors may include, but are not limited to, VGA cables, coaxial cables, twisted pair cables and/or the like for carrying composite video, S-Video and high resolution computer-video. If configured as audio cables, such cables may include two high fidelity audio conductors separately carrying the left and right audio channels.

Transmitter 104 may be configured with a composite video input on a female BNC (bayonet Neill-Concelman) connector, an S-Video input on a female 4-pin mini DIN, a computer-video input on a female 15-pin HD High Definition) connector, and audio connectors. The audio connectors may be RCA type connectors for carrying any standard audio patch cables, as needed.

Twisted pair cable 106 may be configured as a single twisted pair cable bundle or multiple twisted pair cable bundles, depending on the desired configuration of transmitter 104 and receiver 108. Multiple twisted pair cable bundles may be desirable for transmission of different video formats. For example, one twisted pair cable bundle may be used for RGB output with a second twisted pair cable bundle for AV output. The connectors on both ends of the cables may be similar, e.g., male RJ-45 connectors to mate with female RJ-45 connectors on the transmitter and receiver sides.

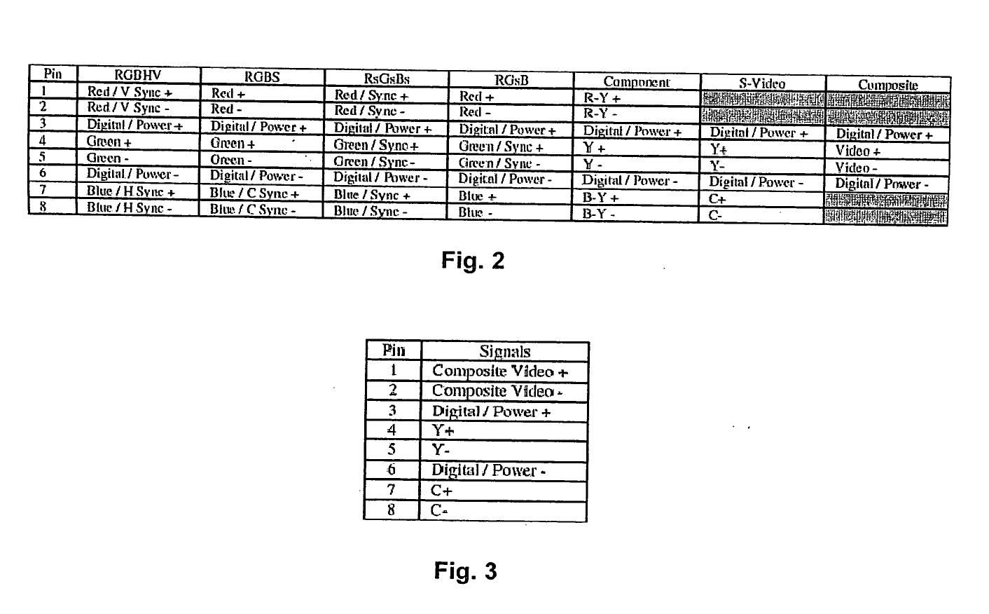

FIG. 2 is an illustration of one allocation of conductors of twisted pair cable 106 for various video formats in accordance with an embodiment of the present invention. Each twisted pair cable bundle may include four pairs of conductors, although in other embodiments different number of conductor pairs may be utilized. Specifically, the first conductor pair may include Pins 1 and 2; the second conductor pair may include Pins 4 and 5; the third conductor pair may include Pins 7 and 8; and the fourth conductor pair may include Pins 3 and 6.

One conductor pair, for example, the fourth pair (i.e. Pins 3 and 6), may be used for digital communication and power transfer. Power transfer may be necessary between transmitter 104 and receiver 108 when the location of one of the devices (i.e. transmitter or receiver) is too remote from an external power source. For instance, in some installations, receiver 108 may be located in close proximity to a destination device 110 (e.g. a projector) and may have easy access to the power source used to power destination device 110. In such case, it may become necessary to transfer power from receiver 108 to transmitter 104, which may be located far away from the projector power source. Destination device 110 receives input from receiver 108 via transmission cable bundle 109, as generally shown in FIG. 1.

Conductor pairs may also be allocated as further illustrated in reference to FIG. 2 or FIG. 3, depending on video format. Note that the pin allocations used herein are for illustrative purposes and convenience in separating the color components. For instance, with RGB video, the signals may be allocated such that Pins 1 and 2 may carry the differential Red signals (i.e. Red+ and Red−); Pins 4 and 5 may carry the differential green signals (i.e. Green+ and Green−); Pins 7 and 8 may carry the differential Blue signals (i.e. Blue+ and Blue−); and Pins 3 and 6 may carry Digital/Power+ and Digital/Power−, respectively.

The sync signals may be summed with the respective color components, as illustrated. For example, when the format to be transmitted is RGBHV (i.e. RGB with separate horizontal and vertical sync signals), the Vertical Sync signal is summed with the Red signal (i.e. Red/V Sync+ and Red/V Sync−); and the Horizontal Sync signal is summed with the Blue signal (i.e. Blue/H Sync+ and Blue/H Sync−). When the format to be transmitted is RGBS (i.e. RGB with one composite sync signal), the composite sync signal may be summed with the Blue signal (i.e. Blue/C Sync+ and Blue/C Sync−).

When the format to be transmitted is RsGsBs (i.e. each color component has its own sync signal), the sync signals are summed with the respective color component signals, as shown in FIG. 2. When the format to be transmitted is RGsB (i.e. only the Green color component has its own sync signal), the differential sync signals are summed with the corresponding green color signal, as shown in FIG. 2.

Component video signals may be allocated such that Pins 1 and 2 carry the differential Red signals (i.e. R-Y+ and R-Y−); Pins 4 and 5 may carry the differential luminance signals (i.e. Y+ and Y−); and Pins 7 and 8 may carry the differential Blue signals (i.e. B-Y+ and B-Y. For S-Video, the signals may be allocated such that Pins 1 and 2 are not used for video; Pins 4 and 5 may carry the differential luminance signals (i.e. Y+ and Y−); and Pins 7 and 8 may carry the differential Chrominance signals (i.e. C+ and C−). For Composite Video, the signals may be allocated such that Pins 1, 2, 7, and 8 are not used; and Pins 4 and 5 carry the differential video signals (i.e. Video+ and Video−).

In another embodiment of the present invention, Composite video and S-Video signals may share the same twisted pair cable 106, as illustrated in FIG. 3. Particularly, the composite video signals may be allocated such that Pins 1 and 2 carry the differential video signals (i.e. “Composite Video”+ and “Composite Video”−); Pins 4 and 5 carry the differential luminance signals (i.e. Y+ and Y−); and Pins 7 and 8 carry the differential Chrominance signals (i.e. C+ and C−). Pins 3 and 6 carry power and digital communication signals, as needed.

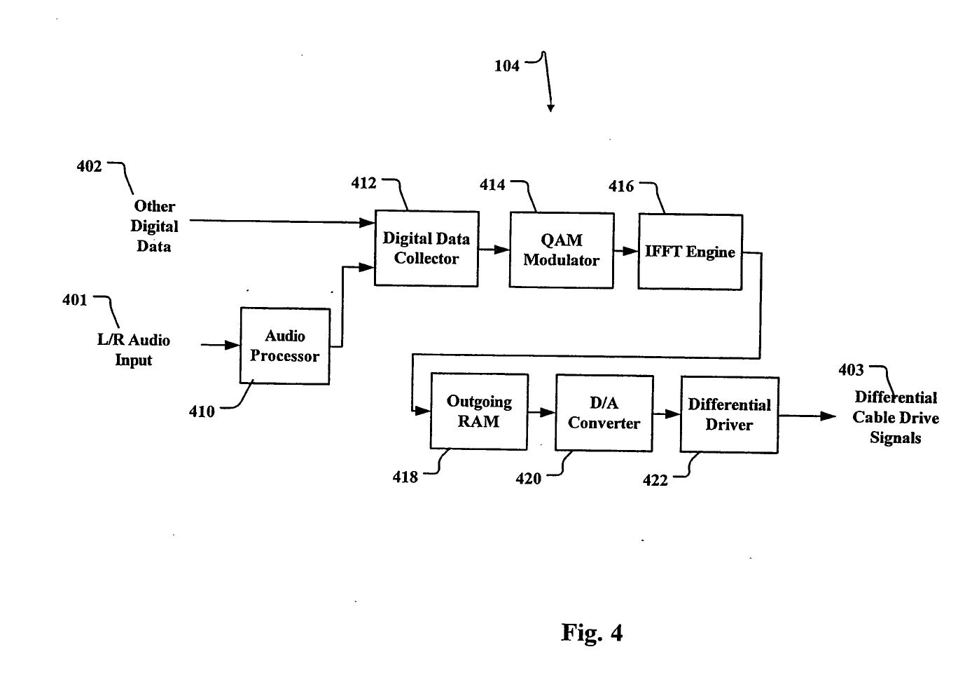

FIG. 4 is a block diagram of an exemplary configuration of transmitter 104 in accordance with an embodiment of the present invention. As generally illustrated in FIG. 4, a digital data collector 412, which may include a shift register, collects and formats various types of data for transmission to receiver 108. Specifically, digital data collector 412 receives input data from an audio processor 410 as well as other digital data 402. Audio processor 410 receives Left/Right audio input 401 and converts the same into a 48-bit digital signal. The 48-bit digital signal is passed on to digital data collector 412 for further processing. Each event is tagged with a time stamp, embedded into a packet and if the packet is full or the maximum timed interval is over, the packet is transmitted.

The packet data is shifted into a QAM modulator 414. QAM (Quadrature Amplitude Modulation) is a modulation scheme which conveys data by changing (modulating) the amplitude of two carrier waves. These two waves, usually sinusoids, are out of phase by 90° and are called quadrature carriers. A CRC (Cyclic Redundancy Check) is generated and appended as the last few bits are shifted into QAM modulator 414. The output from QAM modulator 414 is fed into an IFFT (Inverse Fast Fourier Transform) engine 416 (FIG. 4) for processing.

In one embodiment of the present invention, a sixteen-tone OFDM (Orthogonal Frequency Division Multiplexing) scheme is used to package digital data for transmission. OFDM is a modulation scheme which uses a large number of closely-spaced orthogonal sub-carriers. Each sub-carrier is modulated with a conventional modulation scheme (such as quadrature amplitude modulation) at a low symbol rate, maintaining data rates similar to conventional single-carrier modulation schemes in the same bandwidth.

OFDM signals may be generated using a FFT (Fast Fourier Transform) algorithm. OFDM can handle attenuation of high frequencies at a long copper wire, narrowband interference and frequency-selective fading without complex equalization filters. Channel equalization is simplified because OFDM may be viewed as using many slowly-modulated narrowband signals rather than one rapidly-modulated wideband signal. Low symbol rate makes the use of a guard interval between symbols affordable, making it possible to handle time-spreading and eliminate inter-symbol interference.

OFDM, when compared to PCM (Pulse Code Modulation), provides more robust signaling with reduced crosstalk. Crosstalk is always of concern with data communication over unshielded twisted pair cables (e.g. CAT 5 cable). The video signal has simultaneous high delta voltage edges on all three lines at the same time. This is coupled as noise into the signal line. The crosstalk looks like a C-R high pass response to impulse functions. OFDM averages the signal over all its symbol periods greatly reducing the effect of an impulse. PCM is voltage level sensitive and must respond to these impulses. PCM signals also crosstalk into the video stream. The impulses from PCM are visible as moving waves diagonally across the screen.

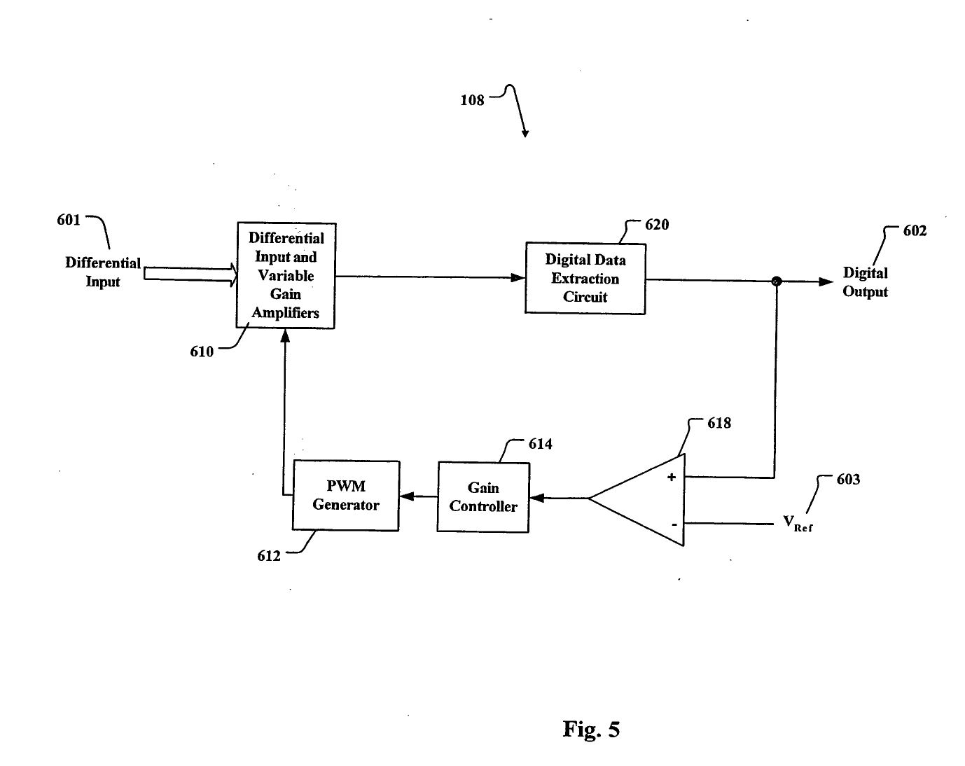

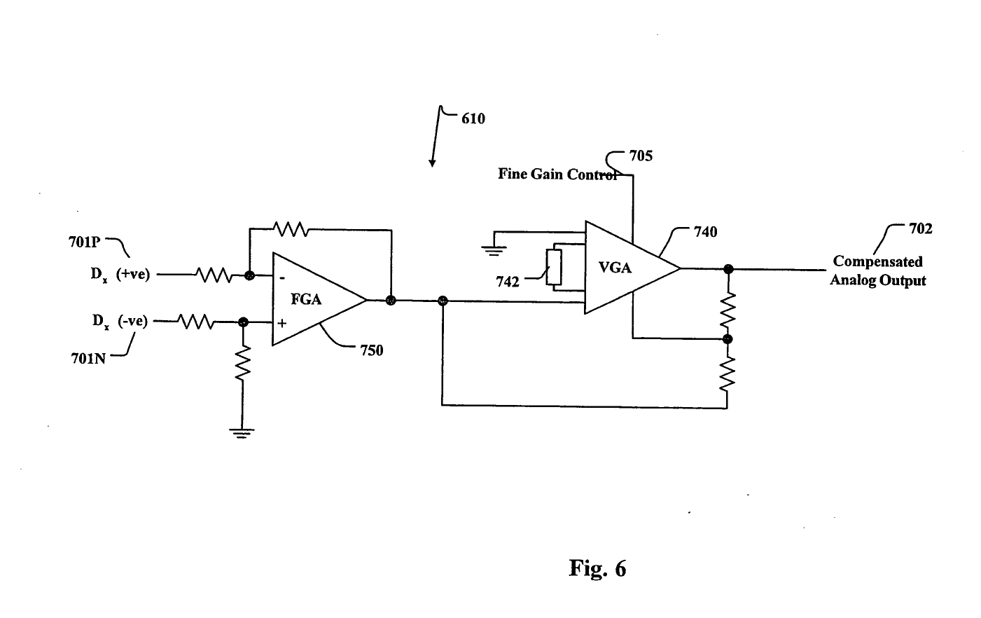

OFDM is used to transmit ten nibbles (4-bit signals) in a single microsecond symbol period. Thus, there are 40 bits in each OFDM symbol. The OFDM symbol may also include a pilot tone which is used for automatic compensation for data losses accumulated during digital communication signal transmission over twisted pair conductors. In another embodiment, two pilot tones are used for automatic data loss compensation. One pilot tone is used as a reference which is communicated on the lowest frequency tone of the digital data (1 MHz). For instance, transmitter 104 may send the first (i.e. fundamental) pilot tone at 1 MHz with the second pilot tone being transmitted at 7 MHz with the 2, 3, 4, 5, 6, 8, 9, and 10 MHz tones containing 16 point QAM signals representing the payload digital information. The digital information may include serial communications data. For example, the digital information may include serial IR (Infra-Red) remote control communications data. In receiver 108, both pilot tones are separated and compared and adjustments are made to compensate the incoming analog signal until both pilot tones match. The functionality of receiver 108 is generally described herein below in reference to FIG. 5.

In addition to its magnitude information, the second pilot determines the phase difference between the digital clock of transmitter 104 and the digital clock of receiver 108 allowing the phase effects to be removed. The phase error of the second pilot is the sum of the error in timing of the fundamental pilot and the phase difference between the remote and local digital clocks. The resultant delay measured by the second pilot is the delay that all tones see because of hardware compensation affecting their individual phases proportionately.

In one embodiment, there are ten OFDM tones available in IFFT 416. Some tones will not be usable due to Nyquist considerations of filtering used in receiver 108. For example, DC is not usable and two tones are allocated to pilots. One embodiment employing a 3rd order anti-aliasing filter results in six of the tones, in the higher frequency region, being unusable. This leaves eight 4-bit slots or 32 bits for transmission of information in the first OFDM symbol. However, since the audio is 48 bits wide, it cannot be sent in one OFDM symbol. Thus, whenever digital data is to be transmitted from one device to another, two or more OFDM symbols may be used for the entire digital communication. The second OFDM symbol has ten 4-bit slots for data transmission. The two packets (OFDM symbols) provide enough bandwidth for the audio and other information such as, but not limited to: packet number for retransmit request because of collision possibility; payload; payload type; order number; error check (CRC), etc. The following table illustrates an exemplary audio packet data allocation in the two transmitted symbols:

| Freq. MHz | Symbol 1 Packet 501 | Symbol 2 Packet 502 |
|---|---|---|
| 1 | Symbol Pilot | CRC (bits 4 to 0) |
| 2 | Right data (7 to 4) | CRC (bits 6 to 5), “00” |
| 3 | Right data (11 to 8) | Left data (7 to 4) |
| 4 | Right data (15 to 12) | Left data (11 to 8) |
| 5 | Right data (19 to 16) | Left data (15 to 12) |
| 6 | Right data (23 to 20) | Left data (19 to 16) |
| 7 | Phase Pilot | Left data (23 to 20) |
| 8 | Right data (3 to 0) | Payload Type (3 to 0) |
| 9 | Packet #(2 to 0), Order #(0) | Left data (3 to 0) |
| 10 | Not Allocated | Not Allocated |
| 11-16 | Not used | Not Used |

The OFDM-QAM encoding results in 4 bits of data being translated to a frequency, which is sent over twisted pair cable 106. As illustrated hereinabove, in first symbol, packet 501, the 1 MHz frequency of the first symbol is allocated for symbol pilot tone; 2 MHz-6 MHz frequencies of the first symbol contain 4 bits each of right channel audio data. 7 MHz contains the second (phase) pilot tone. This pilot finds the phase error of the remote and local clocks. Right audio word bits 3 to 0 are at 8 MHz. The packet number and audio sequence (Order) number are at 9 MHz. The second symbol, packet 502, contains the CRC for the left audio 24-bit word, and a vector indicating payload type—all distributed in the 1 MHz to 9 MHz tones. The 10 MHz and 11-16 MHz tones are not allocated in the first and second symbol. A person skilled in the art would readily appreciate that this is but one of many different bit/frequency allocations, which may be utilized in accordance with general principles of the present invention.

QAM modulator 414 takes the ten nibbles in each symbol and the six unused nibbles, which have zero values, and creates sixteen (16) complex numbers and their complex conjugates. Each complex number (i.e. real and imaginary parts representing the phase and frequency of a sinusoid to be driven outbound) is generated by mapping each sub-carrier, i.e. 4-bit nibble, in the current OFDM symbol using 16-QAM. The resulting thirty two (32) complex numbers are fed to 32 point IFFT engine 416 which generates a set of real numbers (because the input data is a set of complimentary complex numbers, the resultant IFFT output would be a set of real numbers).

This set of real numbers represents the sampled data stream of ten (10) multiple sinusoids whose amplitude and phase are represented by the input QAM vectors. These thirty two (32) real words of 8 bits are stored in a dual-port outgoing RAM (Random Access Memory) 418 (FIG. 4) and kept until overwritten.

The function of RAM 418 is to store the vector in case retransmission is required. The data is read out of RAM 418 and presented to Digital-to-Analog (D/A) converter 420 (FIG. 4). D/A converter 420 puts out one or more symbols followed by a zero Volt pattern when all 32 bytes of the last symbol are written out. The analog output from D/A converter 420 is passed through a differential driver 422 which generates differential cable drive signals 403 (FIG. 4) for transmission to receiver 108 via twisted pair cable 106.

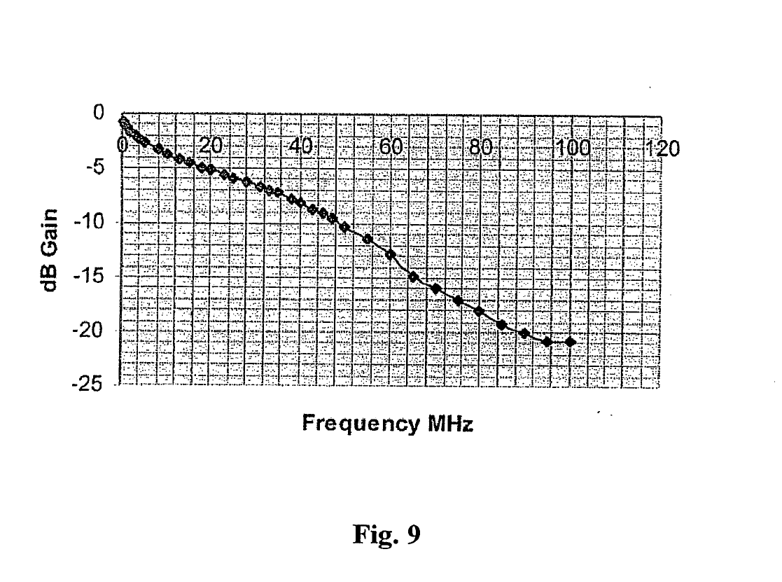

Twisted pair cable 106 may be long enough to result in significant insertion loss at receiver 108. Thus, it may be necessary to determine the amount of signal compensation to be applied at receiver 108 to properly recover the transmitted signal. One way would be to approximate the required signal compensation from the frequency response measurement of a representative cable. In this regard, an exemplary 200 feet CAT 5 UTP cable response is shown in FIG. 9.

As illustrated in FIG. 9, the amplitude loss of a 200 feet CAT 5 UTP cable at 7 MHz is approximately 3.0 dB. Thus, the compensation for a 300 feet cable should produce a gain compensation of 4.5 dB (i.e. 3.0×300/200) at 7 MHz; compensation for a 600 feet cable should produce a gain compensation of 9 dB (i.e. 3.0×3) at 7 MHz; compensation for a 900 feet cable should produce a gain compensation of 18 dB (i.e. 4×4.5) at 11 MHz; compensation for a 1200 feet cable should produce a gain compensation of 24 dB (i.e. 4×6) at 40 MHz; and compensation for a 1500 feet cable should produce a gain compensation of 30 dB (i.e. 4×7.5) at 11 MHz. A person skilled in the art would readily appreciate from reviewing FIG. 9 that the frequency response is directly related to the theoretical gain:

−20*log(exp(K*sqrt(Frequency/M))), where M and K are some constants.

An exemplary table showing the required gain boost (in dB) for various CAT5 cable lengths and frequencies (in MHz) follows herein below:

Required Gain-Boost for Various CAT5 Cable Lengths & Frequencies

(To maintain a flat frequency response at specific frequencies and a given cable length)

| Freq | 100 ft | 200 ft | 300 ft | 400 ft | 500 ft | 600 ft | 700 ft | 800 ft | 900 ft | 1K ft |
|---|---|---|---|---|---|---|---|---|---|---|
| (MHz) | (V/V) | (V/V) | (V/V) | (V/V) | (V/V) | (V/V) | (V/V) | (V/V) | (V/V) | (V/V) |
| 1 | 1.07 | 1.1 | 1.2 | 1.3 | 1.4 | 1.5 | 1.6 | 1.7 | 1.9 | 2.0 |
| 2 | 1.11 | 1.2 | 1.4 | 1.5 | 1.7 | 1.9 | 2.1 | 2.3 | 2.5 | 2.8 |
| 3 | 1.14 | 1.3 | 1.5 | 1.7 | 1.9 | 2.2 | 2.5 | 2.8 | 3.2 | 3.6 |
| 4 | 1.15 | 1.3 | 1.5 | 1.8 | 2.0 | 2.4 | 2.7 | 3.2 | 3.6 | 4.2 |
| 5 | 1.17 | 1.4 | 1.6 | 1.9 | 2.2 | 2.6 | 3.1 | 3.6 | 4.3 | 5.0 |
| 6 | 1.20 | 1.4 | 1.7 | 2.0 | 2.4 | 2.9 | 3.5 | 4.2 | 5.0 | 6.0 |
| 7 | 1.21 | 1.5 | 1.7 | 2.1 | 2.6 | 3.1 | 3.7 | 4.5 | 5.5 | 6.6 |
| 8 | 1.23 | 1.5 | 1.8 | 2.3 | 2.8 | 3.4 | 4.2 | 5.2 | 6.4 | 7.8 |
| 9 | 1.24 | 1.5 | 1.9 | 2.4 | 3.0 | 3.7 | 4.6 | 5.7 | 7.2 | 8.9 |
| 10 | 1.26 | 1.6 | 2.0 | 2.5 | 3.2 | 4.0 | 5.0 | 6.3 | 7.9 | 10 |
| 16 | 1.3 | 1.8 | 2.4 | 3.2 | 4.2 | 5.7 | 7.6 | 10 | 13 | 18 |
| 20 | 1.4 | 1.9 | 2.7 | 3.7 | 5.1 | 7.1 | 10 | 14 | 19 | 26 |
| 31 | 1.5 | 2.3 | 3.4 | 5.1 | 7.7 | 12 | 18 | 26 | 40 | 60 |
| 40 | 1.6 | 2.6 | 4.2 | 6.7 | 11 | 17 | 28 | 45 | 70 | 115 |
| 50 | 1.7 | 2.9 | 5.0 | 8.5 | 15 | 25 | 42 | 72 | 125 | 210 |
| 63 | 1.8 | 3.3 | 6.0 | 11 | 20 | 35 | 65 | 120 | 215 | 390 |
| 70 | 1.9 | 3.5 | 6.7 | 13 | 24 | 45 | 85 | 160 | 300 | 560 |
| 80 | 2.0 | 3.9 | 7.8 | 15 | 31 | 60 | 120 | 240 | 480 | 950 |
| 90 | 2.1 | 4.3 | 9.1 | 19 | 40 | 85 | 170 | 360 | 750 | 1,570 |
| 100 | 2.2 | 4.7 | 10 | 22 | 47 | 105 | 220 | 480 | 1040 | 2,250 |

FIG. 5 is a block diagram of an exemplary configuration of receiver 108 in accordance with an embodiment of the present invention. Receiver 108 includes a differential input and variable gain amplifiers circuit (DIVGAC) 610, a digital data extraction circuit (DDEC) 620, a comparator 618, a gain controller 614, and a PWM generator 612, which are operatively coupled as schematically shown in reference to FIG. 5. DIVGAC 610 receives differential (analog) input 601 with the analog signal being adjusted for DC and peaking (i.e. AC) losses. The adjusted signal is fed into DDEC 620 wherein the digital information is extracted and processed. In one embodiment of the present invention, the extracted data is pilot tone data.

Comparator 618 compares the extracted pilot tone data to V_{ref} 603 which is reference pilot tone waveform data, i.e. transmitted at 1 MHz, for example, as generally shown in FIG. 5. The reference pilot tone waveform can also be a known quantity, e.g., populating the 4-bits of each nibble with ones (i.e. “1111”). Gain controller 614 continually adjusts the gain and peaking in DIVGAC 610 via PWM generator 612 until the desired pilot tone waveform is obtained. The gain and peaking adjustment may be controlled, for example, using a micro-controller which determines the appropriate signal compensation based on actual and expected signal strength. For instance, a closed loop system including a negative feedback circuit, which eliminates any noise glitches by low pass filtering, may be used to determine and apply the appropriate compensation.

FIG. 6 schematically illustrates one embodiment of a differential gain and peaking network circuit which may be implemented in DIVGAC 610 in accordance with the present invention. Particularly, differential analog input signals Dₓ(+ve) 701P and Dₓ(−ve) 701N from twisted pair cable 106 are fed into a FGA (Fixed Gain Amplifier) 750 which converts the differential signals into a single-ended output. The single-ended output of FGA 750 is provided to a VGA (Variable Gain Amplifier) 740 wherein the proper compensation is added. VGA 740 is controlled by fine gain control 705 (i.e. output of PWM generator 612) and utilizes compensator circuit 742, as shown in FIG. 6, to set the appropriate DC and AC compensation for the cable length.

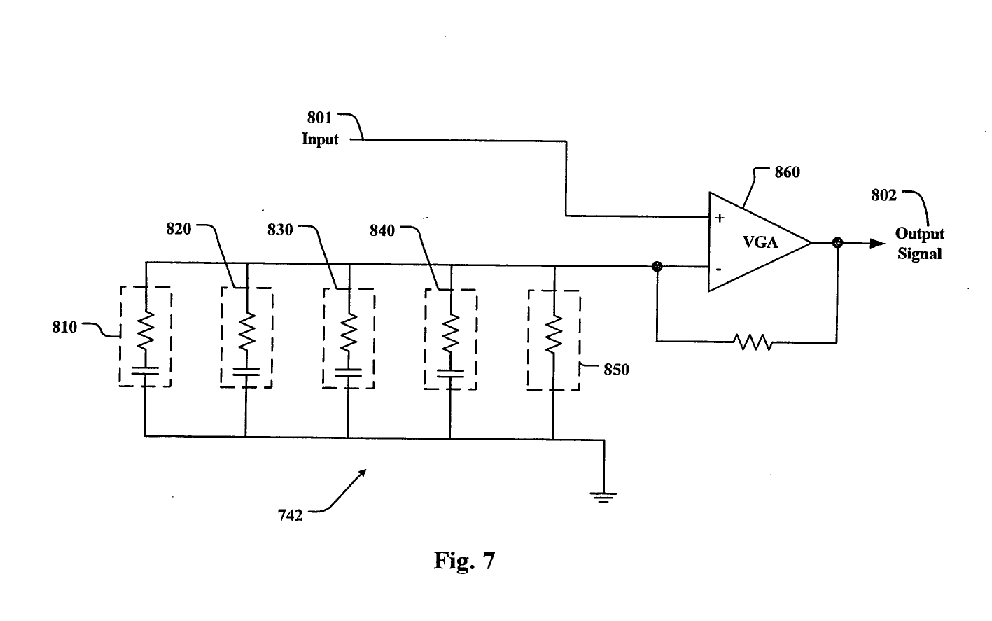

Compensator circuit 742 is configured such that the desired compensation may be obtained by changing the duty cycle of fine gain control 705. One possible embodiment of AC and DC compensator circuit 742 is schematically depicted in reference to FIG. 7. Specifically, AC signal amplitude loss is compensated for by the addition of peaking (RC) networks 810, 820, 830, and 840 which are coupled in parallel to a DC gain setting resistor 850 of a VGA 860. VGA 860 receives input 801 and generates a corresponding compensated output signal 802 (FIG. 7). Changing the gain of VGA 860 changes the amount of peaking compensation.

Each peaking network may consist of a plurality of poles individually staggered to compensate for high frequency losses and delay distortion between amplifier stages. The combination of elements in each peaking network compensates for cable signal loss in amplitude and phase characteristics across the required frequency spectrum. Limiting the useful gain of each amplifier stage and using multiple gain stages increases the usable bandwidth of each amplifier stage.

A person skilled in the art would recognize that even though four RC networks are used in this illustration, the actual number of peaking networks utilized in any particular implementation would depend on the frequency range of interest for the transmission of digital signal and the transfer function characteristics of twisted pair cable 106. In other words, the compensation would depend on the desired bandwidth for communication. In this illustration, each RC network represents a certain frequency range, thus a cascade of several RC networks may be needed to account for the entire usable bandwidth.

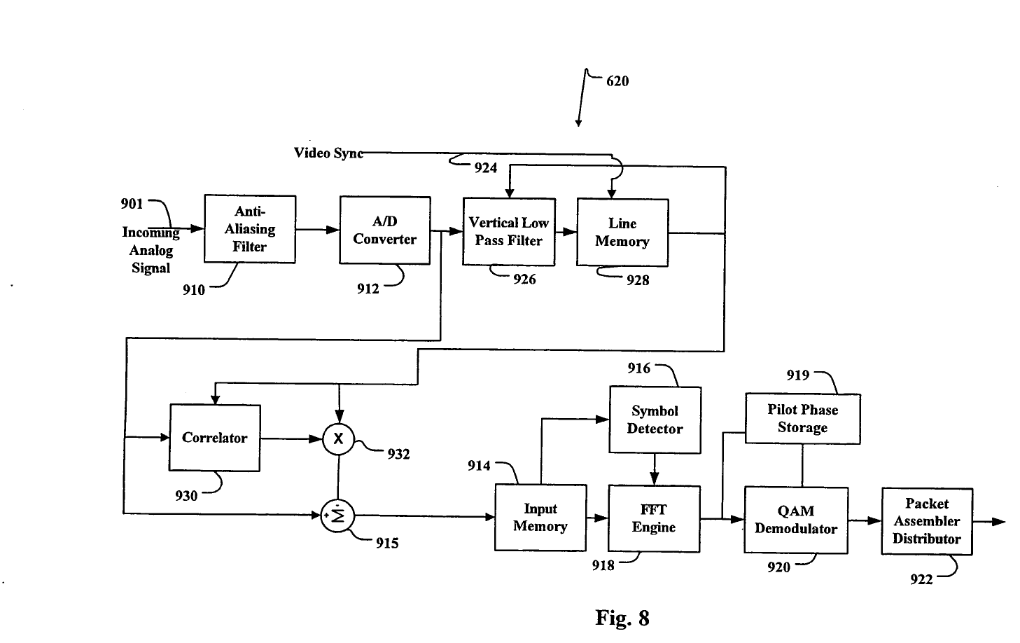

Compensated analog output 702 (FIG. 6) is processed by DDEC 620 (FIG. 5) which extracts the digital information contained therein. FIG. 8 is a schematic illustration of an exemplary embodiment of DDEC 620 in accordance with the general principles of the present invention. Particularly, digitized input data is generated from incoming analog signal 901 using A/D converter 912 after filtering the same via anti-aliasing filter 910. In one embodiment, the digitized input data is continually shifted into input memory 914 (FIG. 8) until an OFDM symbol is detected.

Symbol detection is performed in a symbol detector 916 (FIG. 8) which may be implemented as a small FFT (e.g. 8×8) engine 1008 (FIG. 11) which is suitable for processing the pilot tone sub-carrier. A symbol is detected upon completion of the 1 MHz pilot tone cycle. For example, the data in input memory 1002 (FIG. 11) may be processed through a well damped digital maximally flat low pass filter 1004 (FIG. 11) and then stored in temporary memory 1006 (FIG. 11). The stored data may be down-sampled and scanned by small (8×8) FFT engine 1008 every cycle to generate imaginary and real data components 1010, 1012 (FIG. 11), respectively. The imaginary and real data outputs (1010, 1012) of small (8×8) FFT engine 1008 may subsequently be used to detect the zero phase point of the pilot tone (fundamental frequency) in the OFDM symbol.

In one or more exemplary embodiments, the symbol is detected with no phase error the instant the real and imaginary portions of the FFT outputs are in quadrature, i.e., with the real data portion 1012 (FIG. 11) of small (8×8) FFT engine 1008 (FIG. 11) at zero and the imaginary data portion 1010 (FIG. 11) of small FFT engine 1008 at maximum (i.e. 1 and 0 as the imaginary and real 8×8 FFT outputs). More specifically, when receiving the prefixed cosine wave data (data input to symbol detector 916) the imaginary magnitude has maxima with the real magnitude having minima. This condition may be defined as a precursor condition. When the real magnitude peaks with the imaginary magnitude having minima, the zero phase of the incoming cosine wave is found.

The real and imaginary FFT outputs may be fed into absolute value circuits for sign detection. The signs of real and imaginary FFT outputs 1010, 1012 are used to determine if the phase of the pilot is about 0 radians or at it radians. A signal stopdetect module 1014 (FIG. 11), which is operatively coupled to temporary memory 1006 (FIG. 11), clears out the storage inside the symbol detector to prevent residue from being mistaken for a new symbol.

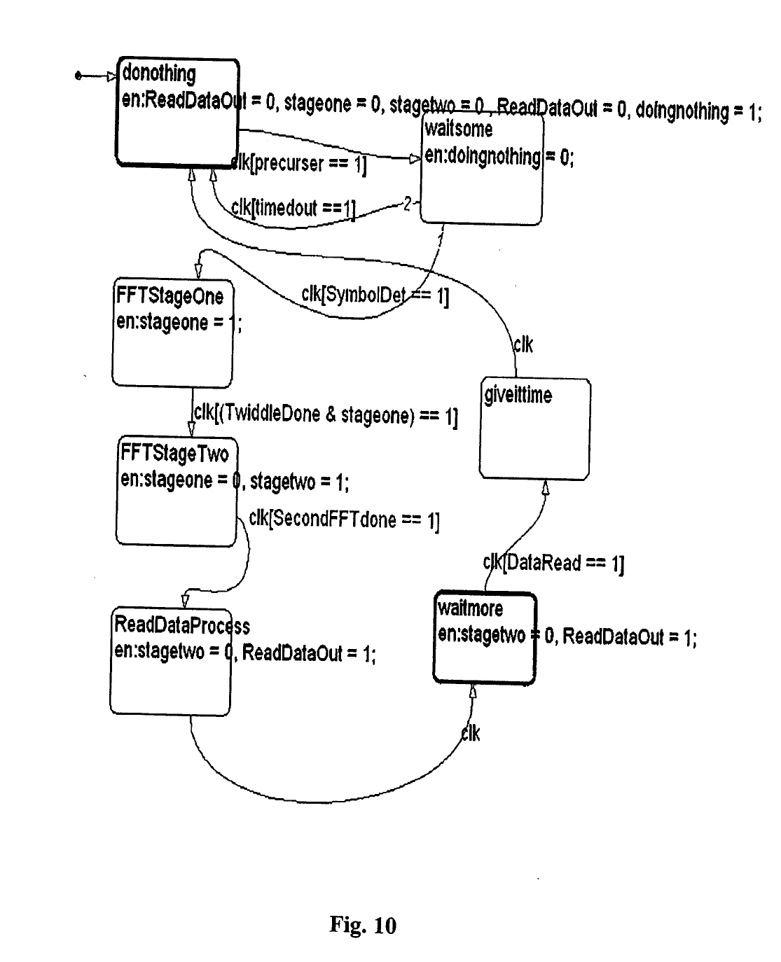

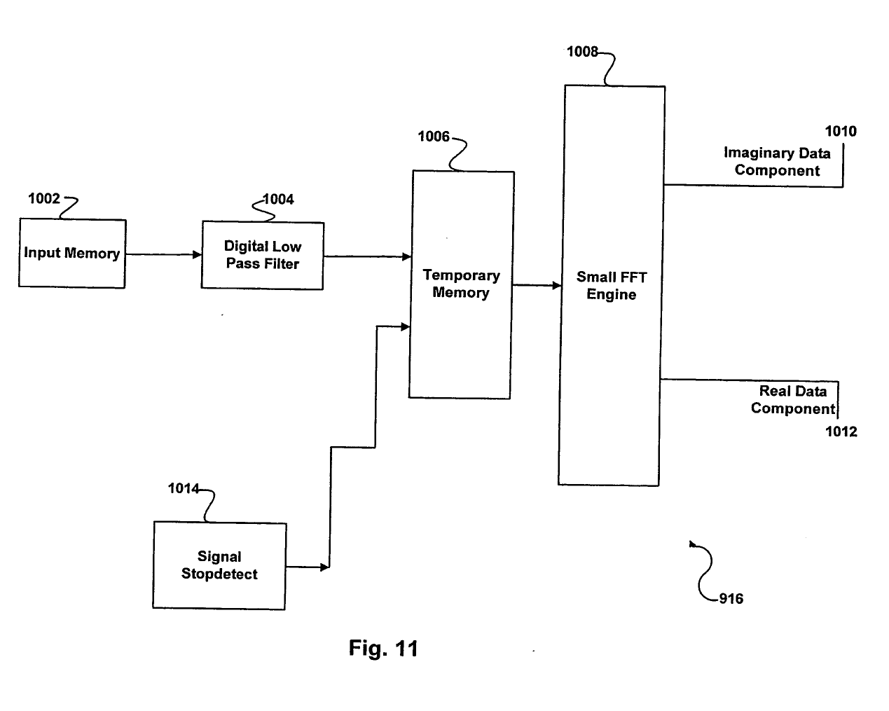

FIG. 10 is an exemplary state diagram of a state machine which controls the FFT initiated by a symbol detect pulse in accordance with an embodiment the present invention. When the precursor is “true,” the state machine advances to “waitsome.” If the precursor is not followed in a timely manner, the state machine returns to “donothing,” but if the symbol is detected, it advances to “FFTStageOne” during which 32 real input bytes are processed by the 8×8 FFT, multiplied by the twiddle factor, and stored in suitable memory for the 4×4 process. When the “twiddleDone” signal is asserted, the state machine advances to “FFTStageTwo” during which the 4×4 FFT processes the data producing the 32 complex numbers which represent phase and magnitude or the input frequencies. The “ReadDataProcess” state takes the data out of the 4×4's destination memory to the appropriate output queue memory.

As configured, input memory 914 contains all the data transmitted in the same baud period as the pilot tone at the instant the pilot tone symbol is detected. In other embodiments, there may be some other timing relationship. When the complete packet is received, a full FFT Engine 918 (FIG. 8) reads the data in memory 914 and generates the real and imaginary components of the input data. The real and imaginary FFT outputs are presented to a QAM demodulator 920 (FIG. 8) which calculates the magnitude to determine which ring the data is in.

In one or more exemplary embodiments, the FFT outputs are 32 complex numbers, 16 of which are conjugates of the other 16. The complex number outputs are fed into QAM demodulator 920. The magnitude squared is these two values squared and added together to give the ring number. The delay of every super carrier is off by the same amount of time as the pilot. The phase diagram is broken into 17 areas-16 valid data regions and invalid regions. The quantization of both the real and imaginary values is 5 bits. There is no phase error. The signs of the real and imaginary numbers determine the relevant QAM quadrant. The magnitude of the vector determines which ring the data is in. Taking the arctangent via an embedded look up table determines the phase of the complex number.

QAM demodulator 920 (FIG. 8) is coupled to pilot phase storage 919. QAM demodulator 920 performs the inverse of the process performed by QAM modulator 414 (FIG. 4). In addition, QAM demodulator 920 may be configured to reject the incoming data when the value is below a certain minimum magnitude or above a certain maximum magnitude. The output of QAM demodulator 920 is stored in a packet assembler distributor 922 wherein it is made available for any additional processing. For instance, the audio data may be routed to an appropriate output device and the control information may be used for video processing.

Video may crosstalk into the digital data, but in-band video is highly redundant on a raster's vertical axis so it is practical to predict the value of the crosstalk relative to its position on a line. Crosstalk is noise which will increase the error rate of decoded data. FFT engine 918 analyzes 32 words of data in parallel mode averaging much of the random crosstalk effects away. However, video may have an in-band regular pattern that may not average away. Multiburst is such a signal with the added disadvantage of being present for most of the time. With a 30 MHz sample clock, it requires 2K words to store one line, which can easily fit in an embedded FPGA (Field-Programmable Gate Array) RAM. If the current line is correlated with the previous line then that signal subtracted from the current line would remove video crosstalk from the incoming digital signal. Note that a negative correlation will also result in the removal of crosstalk.

A vertical low pass filter 926 along with line memory 928 extracts the lines representation of raster vertical features of the video, as shown in reference to FIG. 8. A correlator 930 generates an output from −1 to 0 to 1 multiplying (932) the expected crosstalk value, which results in a value to be subtracted (915) from the incoming signal. If the two signals are uncorrelated, the output of correlator 930 is zero.

A person skilled in the art would readily recognize that embedding the pilot tones in the symbol period along with data allows multiple sources of digital data to time division multiplex the data over the same pair of wires. Time Division Multiplexing (TDM) is a type of digital multiplexing in which two or more bit streams are transferred simultaneously as sub-channels in one communication channel, but physically are taking turns on the channel. The time domain is divided into recurrent timeslots of fixed length, one for each sub-channel. Particularly, digital data collector 412 may be configured to act as an arbiter which time division multiplexes multiple data sources. For example, three stereo A/D converters, two serial ports and miscellaneous data may be time division multiplexed into the data stream to remote destination device 110.

A person skilled in the art would also recognize that embodiments of the present invention are capable of extending the transmission capabilities of twisted pair audio/video communication systems by several multiple times the distance of known twisted pair audio/video communication systems. The exemplary embodiments described hereinabove are merely illustrative of the general principles of the present invention. Various design modifications may be employed that would reside within the scope of the invention. Thus, by way of example, but not of limitation, various alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed is:

1. An apparatus for extending the transmission capability of twisted pair communication systems, comprising:
a transmitter utilizing orthogonal frequency division multiplexing (OFDM) to package digital data for transmission, said packaged digital data including at least one embedded pilot tone for data loss compensation, said transmitter configured to generate analog differential output from said packaged digital data; and
a receiver operatively coupled to said transmitter over at least one twisted pair cable and configured to recover said at least one embedded pilot tone from said analog differential output, said receiver utilizing a closed loop feedback system and said at least one recovered pilot tone to apply corresponding signal compensation to said analog differential output, said receiver further configured to extract the transmitted digital data from said compensated signal.

2. The apparatus of claim 1, wherein a sixteen-tone OFDM scheme is used to package digital data for transmission.

3. The apparatus of claim 1, wherein said transmitter uses a digital data collector to prepare packet data from a plurality of data sources.

4. The apparatus of claim 3, wherein at least one of said plurality of data sources is an audio processor.

5. The apparatus of claim 4, wherein said audio processor includes left/right audio input and is configured to convert input data into a 48-bit digital signal.

6. The apparatus of claim 5, wherein said 48-bit digital signal is passed on to said digital data collector for processing.

7. The apparatus of claim 4, wherein another data source feeds other digital data to said digital data collector for processing.

8. The apparatus of claim 4, wherein said sixteen-tone OFDM scheme is used to transmit ten nibbles in a single symbol period.

9. The apparatus of claim 8, wherein said symbol includes said at least one pilot tone.

10. The apparatus of claim 9, wherein one pilot tone is used as a reference signal which is communicated on the lowest frequency of the digital data.

11. The apparatus of claim 8, wherein the 1 MHz frequency of said symbol is allocated for symbol pilot tone.

12. The apparatus of claim 11, wherein the 7 MHz frequency of said symbol is allocated for phase pilot tone.

13. The apparatus of claim 12, wherein said phase pilot tone is utilized to determine the phase difference between the digital clock of said transmitter and the digital clock of said receiver allowing the phase effects to be removed.

14. The apparatus of claim 8, wherein said transmitter uses a QAM (Quadrature Amplitude Modulation) modulator to receive the ten nibbles in each symbol and the six unused nibbles and generate sixteen complex numbers and their complex conjugates.

15. The apparatus of claim 14, wherein each of said complex numbers is generated by mapping each sub-carrier in the current OFDM symbol using 16-QAM.

16. The apparatus of claim 15, wherein said generated complex numbers are fed to an IFFT (Inverse Fast Fourier Transform) engine for processing.

17. The apparatus of claim 16, wherein said IFFT engine generates a set of real words representing the sampled data stream of a plurality of sinusoids whose amplitude and phase are determined by the input QAM vectors.

18. The apparatus of claim 17, wherein said set of real words is stored in a dual-port outgoing RAM (Random Access Memory) and kept until overwritten.

19. The apparatus of claim 18, wherein the stored data is read out of said RAM and presented to a D/A (Digital-to-Analog) converter.

20. The apparatus of claim 19, wherein said D/A converter puts out at least one symbol followed by a zero Volt pattern when all 32 bytes of the last symbol are written out.

21. The apparatus of claim 20, wherein the analog output of said D/A converter is passed through a differential driver.

22. The apparatus of claim 21, wherein said differential driver generates a plurality of differential cable drive signals for transmission to said receiver over said at least one twisted pair cable.

23. The apparatus of claim 22, wherein said receiver uses a Differential Input and Variable Gain Amplifiers Circuit (DIVGAC) differential driver to process said plurality of differential cable drive signals.

24. The apparatus of claim 23, wherein signal processing by said DIVGAC includes adjusting the received analog signal for DC and AC losses.

25. The apparatus of claim 24, wherein the adjusted analog signal is being fed into a Digital Data Extraction Circuit (DDEC) wherein the transmitted digital information is extracted and processed.

26. The apparatus of claim 25, wherein the extracted data contains pilot tone data.

27. The apparatus of claim 26, wherein said receiver uses a comparator to compare the extracted pilot tone data to reference pilot tone waveform data.

28. The apparatus of claim 27, wherein the reference pilot tone waveform data is a known quantity.

29. The apparatus of claim 28, wherein said receiver utilizes a gain controller to adjust the gain and peaking in said DIVGAC via a PWM (Pulse Width Modulation) generator until the desired pilot tone waveform is obtained.

30. The apparatus of claim 29, wherein the gain and peaking adjustment is controlled by way of a micro-controller which determines the appropriate signal compensation based on actual and expected signal strength.

31. The apparatus of claim 29, wherein said closed loop feedback system includes a negative feedback circuit which eliminates noise glitches by low pass filtering.

32. The apparatus of claim 28, wherein said DIVGAC includes a differential gain and peaking network circuit.

33. The apparatus of claim 32, wherein said differential gain and peaking network circuit includes at least one FGA (Fixed Gain Amplifier) which converts the differential signals into a single-ended output.

34. The apparatus of claim 33, wherein said single-ended output is provided to at least one VGA (Variable Gain Amplifier) which adds the required compensation.

35. The apparatus of claim 34, wherein said at least one VGA uses fine gain control and a compensator circuit to set the requisite DC and AC compensation for the required length of said at least one twisted pair cable.

36. The apparatus of claim 35, wherein said compensator circuit is configured such that the desired compensation is obtained by changing the duty cycle of said fine gain control.

37. The apparatus of claim 35, wherein said compensator circuit includes at least one peaking RC network coupled in parallel to the DC gain setting resistor of said at least one VGA.

38. The apparatus of claim 37, wherein changing the gain of said at least one VGA changes the amount of peaking compensation.

39. The apparatus of claim 38, wherein each peaking network includes a plurality of poles individually staggered to compensate for high frequency losses and delay distortion between amplifier stages.

40. The apparatus of claim 39, wherein each peaking network is configured to compensate for cable signal loss in amplitude and phase characteristics across the required frequency spectrum.

41. The apparatus of claim 39, wherein limiting the useful gain of each amplifier stage and using multiple gain stages increases the usable bandwidth of each amplifier stage.

42. The apparatus of claim 25, wherein said DDEC generates digitized input data from the incoming analog signal by way of a A/D (Analog-to-Digital) converter which is operatively coupled to an anti-aliasing filter.

43. The apparatus of claim 42, wherein the digitized input data is continually shifted into input memory until an OFDM symbol is detected.

44. The apparatus of claim 43, further comprising a symbol detector which is utilized to detect said OFDM symbol.

45. The apparatus of claim 44, wherein said symbol detector is implemented as a first FFT (Fast Fourier Transform) engine which is configured to process the pilot tone sub-carrier.

46. The apparatus of claim 45, wherein data in said input memory is processed through a well damped low pass filter and stored in temporary memory.

47. The apparatus of claim 46, wherein the stored data is down-sampled and scanned by said first FFT every cycle to generate the real and imaginary components of the data.

48. The apparatus of claim 47, wherein the generated real and imaginary outputs of said first FFT are used by said symbol detector to detect the zero phase point of said at least one pilot tone in said OFDM symbol.

49. The apparatus of claim 48, wherein said OFDM symbol is detected with no phase error when the real and imaginary portions of said outputs of said first FFT are in quadrature.

50. The apparatus of claim 49, further comprising a state machine which controls said first FFT initiated by a symbol detect pulse.

51. The apparatus of claim 49, wherein said input memory contains all the data transmitted in the same baud period as the pilot tone when said at least one pilot tone symbol is detected.

52. The apparatus of claim 51, wherein a second FFT engine reads the data in said input memory and generates the real and imaginary components of the input data when a complete data packet is received in said input memory.

53. The apparatus of claim 52, wherein the output of said second FFT engine is fed into a QAM demodulator for decoding.

54. The apparatus of claim 53, wherein said QAM demodulator is operatively coupled to pilot phase storage.

55. The apparatus of claim 53, wherein said QAM demodulator is configured to reject incoming data when a respective value is below a certain minimum magnitude.

56. The apparatus of claim 53, wherein said QAM demodulator is configured to reject incoming data when a respective value is above a certain maximum magnitude.

57. The apparatus of claim 53, wherein the output of said QAM demodulator is stored in a packet assembler distributor wherein it is made available for additional processing.

58. The apparatus of claim 52, wherein said second FFT engine is configured to analyze a plurality of data words in parallel mode averaging a substantial amount of random crosstalk effects away.

59. The apparatus of claim 25, wherein said DDEC further comprises a vertical low pass filter operatively coupled to line memory.

60. The apparatus of claim 59, wherein said vertical low pass filter and line memory extract the lines representation of raster vertical features of a video signal.

61. The apparatus of claim 60, wherein the extracted signal is provided to a correlator which generates an output from −1 to 0 to 1 multiplying the expected crosstalk value, which results in a value to be subtracted from the incoming signal.

62. The apparatus of claim 61, wherein said correlator is operatively coupled between said line memory and said input memory.

63. An apparatus for extending the transmission capability of twisted pair communication systems, comprising:
a transmitter configured to generate a plurality of analog signals; and
a receiver operatively coupled to said transmitter over at least one twisted pair cable and configured to apply compensation to said plurality of analog signals, at least one of said analog signals being encoded with pilot tone and digital information, said compensation being generated by way of a variable compensation circuit which includes an active filter network with control signal based on said pilot tone, said receiver remotely disposed from said transmitter and including a digital data extraction circuit for recovering the digital information from the compensated analog signals.

64. The apparatus of claim 63, wherein said pilot tone is a low frequency pulse on at least one of said analog signals.

65. The apparatus of claim 63, wherein said pilot tone originates from said transmitter.

66. The apparatus of claim 63, wherein said pilot tone is frequency division multiplexed with the digital information.

67. The apparatus of claim 63, wherein said receiver further includes a pulse width modulator operatively coupled to a comparator via a gain controller.

68. The apparatus of claim 67, wherein said comparator operates on said pilot tone and a known reference tone.

69. The apparatus of claim 68, wherein said control signal is output from said pulse width modulator.

70. The apparatus of claim 63, wherein the digital information is quadrature amplitude modulated.

71. The apparatus of claim 63, wherein the digital information includes audio data.

72. The apparatus of claim 63, wherein the digital information includes serial communications data.

73. The apparatus of claim 63, wherein the digital information includes serial IR (Infra-Red) remote control communications data.

74. The apparatus of claim 63, wherein an additional pilot tone is used to find and compensate for phase differences between the remote clock of said transmitter and the local clock of said receiver.

75. The apparatus of claim 63, wherein pilot tones are used to measure the degradation of all four pairs of at least one interconnecting twisted pair cable and generate appropriate compensation signals for the other three pairs.

76. The apparatus of claim 63, wherein said transmitter includes a digital data collector which receives data from a plurality of sources.

77. The apparatus of claim 76, wherein said digital data collector acts as an arbiter which time division multiplexes said plurality of data sources.

78. The apparatus of claim 76, wherein a plurality of stereo A/D converters, a plurality of serial ports and miscellaneous data are time division multiplexed into the data stream to said remote receiver via said digital data collector.

79. The apparatus of claim 63, wherein said receiver is configured to predict and remove crosstalk from an incoming signal.

80. The apparatus of claim 63, wherein said receiver is configured to remove in-band crosstalk from an incoming RGB multiburst signal.

81. A method for extending the transmission capability of twisted pair communication systems, said method comprising the steps of:
receiving an analog signal over at least one twisted pair cable, wherein said analog signal includes at least one pilot tone embedded with other digital information;
applying compensation to said analog signal to generate a compensated analog signal, wherein said compensation includes frequency dependent gain and phase adjustments to said analog signal based on deviation of said at least one pilot tone from a reference tone; and
extracting the other digital information from the compensated analog signal.

82. The method of claim 81, wherein said reference tone is a low frequency pulse transmitted via said at least one twisted pair cable.

83. The method of claim 81, wherein said reference tone is injected into said at least one twisted pair cable at a transmitter.

84. The method of claim 81, wherein said at least one pilot tone is frequency division multiplexed with the other digital information.

85. The method of claim 81, wherein said compensation includes a variable gain stage that is controllable with a signal proportional to the deviation of said at least one pilot tone from said reference tone.

86. The method of claim 81, wherein said extracting step comprises:
converting the compensated analog signal to a digital signal;
analyzing the digital signal for the presence of a symbol; and
recovering the other digital information from the digital signal when said symbol is present.

87. The method of claim 86, wherein the digital signal is quadrature amplitude modulated.

88. The method of claim 81, wherein the other digital information includes audio data.

89. The method of claim 81, wherein the other digital information includes serial communications data.

90. The method of claim 81, wherein the other digital information includes serial IR (Infra-Red) remote control communications data.

91. A method for extending the transmission capability of twisted pair communication systems, said method comprising the steps of:
providing a transmitter which utilizes orthogonal frequency division multiplexing (OFDM) to package digital data for transmission;
embedding at least one embedded pilot tone for data loss compensation in the packaged digital data;
generating analog differential output from the packaged digital data;
operatively coupling a receiver to said transmitter over at least one twisted pair cable;
configuring said receiver to recover said at least one embedded pilot tone from the analog differential output;
utilizing a closed loop feedback system and said at least one recovered pilot tone in said receiver to apply corresponding signal compensation to the analog differential output; and
extracting the transmitted digital data from the compensated signal.

92. The apparatus of claim 46, further comprising a signal stopdetect module.

93. The apparatus of claim 92, wherein said signal stopdetect module is operatively coupled to said temporary memory and used to clear out the storage inside said symbol detector to prevent residue from being mistaken for a new symbol.
